(19) United States
(12) Patent Application Publication
(10) Pub. No.: US 2015/0154358 A1
(43) Pub. Date: Jun. 4, 2015

(54) COMPUTER GENERATING AND MODIFYING MEDICAL RECORDS TO COMPLY WITH CUSTOMER RESTRICTIONS

(71) Applicants: Nicholas G. Anderson, Knoxville, TN (US); John S. Pollack, Naperville, IL (US); David F. Williams, Minnetonka, MN (US)

(72) Inventors: Nicholas G. Anderson, Knoxville, TN (US); John S. Pollack, Naperville, IL (US); David F. Williams, Minnetonka, MN (US)

(21) Appl. No.: 14/253,443

(22) Filed: Apr. 15, 2014

Related U.S. Application Data
(63) Continuation-in-part of application No. 14/077,714, filed on Nov. 12, 2013.
(60) Provisional application No. 61/841,977, filed on Jul. 2, 2013.
(60) Provisional application No. 61/826,677, filed on May 23, 2013.
(60) Provisional application No. 61/781,125, filed on Mar. 14, 2013.
(60) Provisional application No. 61/725,709, filed on Nov. 13, 2012.

(51) Int. Cl. G06F 19/00

(52) U.S. Cl. CPC G06F 19/322

(57) ABSTRACT

Medical records are created and modified based upon the needs of the user. In addition to selecting information needed by a user from a database, the present invention identifies and eliminates information from the medical records that is not needed or wanted. A computer database is created by receiving from healthcare providers a plurality of electronic encounter records. The computer further receives input data relating to the medical information that the customer wishes to include in the desired report. The input data may include items to be included in the report or items to be excluded from the report. The computer analyzes the patient encounter records in the database to identify and select a subset of patient encounter records based on the input data. The computer analyzes the subset of patient encounter records to identify and remove medical information to thereby create a sub-subset of medical information again based on the input data provided by the customer. A desired report is computer generated from the patient encounter records based on the sub-subset of medical information.

### CROSS-REFERENCE TO RELATED APPLICATIONS

This application claims priority to and is a continuation in part of U.S. application Ser. No. 14/077,714 filed Nov. 12, 2013, entitled Healthcare Data Management System, which claims priority to Provisional patent applications: Application No. 61/725,709 filed Nov. 13, 2012; Application No. 61/781,125 filed Mar. 14, 2013; Application No. 61/826,677 filed May 23, 2013 and Application No. 61/841,977 filed Jul. 2, 2013; all of the above-referenced application having inventors: Nicholas G. Anderson, John S. Pollack and David F. Williams

### FIELD

This invention relates to the field of computer generation of medical records for customers and particularly relates to computer generation and modification of medical records for customers that are subject to specific rules or restrictions on the content of medical records.

### BACKGROUND

Medical records are created and reviewed for a variety of purposes. For example, universities and other research facilities obtain and modify medical records for pure research purposes. Medical records include records from patient charts, electronic health records, medical billing records, drug-inventory system records, and any other health record. Also, companies that produce medicines or medical products study medical records to judge and improve the effectiveness, efficiency and acceptance of their products. Because of government laws, rules and regulations, some companies are careful to avoid some type of information about their own products. For example, medical products are often used by doctors for purposes and treatments that are not approved by the FDA. These uses are sometimes called off-label uses. A company is not allowed to promote off-label uses of its products and therefore some companies avoid any research that might include a review of medical records depicting off-label use of their products. Such research might be construed as an attempt to promote the off-label use. This self-imposed or government imposed handicap reduces the ability of companies and other researchers to fully and completely research medical records with respect to certain drugs and other medical products.

In accordance with the present invention, medical records are created and modified based upon the needs of the user, also called a customer. In addition to selecting information needed by a user from a database, the present invention identifies and eliminates information from the medical records that is not needed or wanted. For example, a particular customer may be interested in researching actual medical records concerning the use of a drug, but it may be inappropriate for the company to study medical records related to off-label use of the drug. Government rules might actually forbid a drug manufacturer from studying such off-label uses in some circumstances. So to comply with applicable laws and rules, a drug manufacturer may avoid particular types of medical records related to off-label use. However, even medical records relating to off-label uses may be useful in particular research related to particular drugs. The present invention has recognized a need to provide a special form of medical records in which certain types of medical information is removed from the medical report so that the medical records may be considered, but the records will not include information that a customer does not wish to see for whatever reason.

In accordance with one embodiment of the present invention, a method is disclosed for computer creating a desired report from a computer database of health information. The desired report is prepared for a customer who provides input data indicating the type of report desired. A computer database is created by receiving from healthcare providers a plurality of electronic encounter records. Each encounter record includes medical information. The computer further receives input data relating to the medical information that the customer wishes to include in the desired report. The input data may include items to be included in the report or items to be excluded from the report. The computer analyzes the patient encounter records in the database to identify and select a subset of patient encounter records based on the input data. The computer analyzes the subset of patient encounter records to identify and remove medical information to thereby create a sub-subset of medical information again based on the input data provided by the customer. A desired report is computer generated from the patient encounter records based on the sub-subset of medical information.

The input data controls what medical information is included and excluded in a desired report, but it does not necessarily do so directly. The meaning of the input data may be controlled by internal rules. For example, if a customer identifies codes that should be included in the desired report, an internal rule may provide that all other codes should be redacted from the report. Thus, by identifying included codes, the customer has indirectly identified excluded codes as well. Likewise, the customer may identify excluded codes, and the program may have an internal rule that will redact all of the excluded codes, but all of the remaining medical information including other codes will be included in the desired report. Thus, by identifying excluded codes, the customer has also identified what information should be included in the report. The internal rules are crafted based on government regulations that sometimes forbid the company to view certain types of data. For example, a drug manufacturer may be forbidden from investigating unapproved uses of a particular drug. In such case, if a customer identifies a particular drug as included data, an internal rule may provide that all codes and words relating to known unapproved uses of that drug should be redacted from the report.

The input data may include one or more desired codes or words that the customer wishes to include in the report. In such case the computer may identify and select the subset of encounter records to include encounter records with the desired codes or words or both. Other codes may be included in this subset as well. The computer may then analyze the subset to remove (redact) the other codes (not the desired codes). The computer then generates the desired report to include the desired codes or words and other medical information but not including the other codes or words. In addition, words or other information related to the other codes or words may be similarly redacted from the final report to the customer.

In another embodiment the customer may identify one or more excluded codes and/or words that the customer wishes to exclude from the report. Based on the excluded codes or words or both, the computer creates the subset and sub-subset. The sub-subset may include medical records that originally contained the excluded codes or words, but such excluded codes and/or words are now redacted. Alternatively, records containing the excluded codes or words may be removed entirely.

In accordance with a more particular embodiment, the computer may identify first and second groups of diagnosis codes based on the input data. Then, patient encounter records that include the first group are included in the subset. The sub-subset is created by excluding information from the subset based on the second group. Entire records may be excluded or portions of records excluded based on the second group of diagnosis codes.

The program may further identify additional included or excluded items based on either included or excluded items. For example, if a particular diagnosis code is indicated as an included item, then the words used to identify the diagnosis would be generated as additional included items. However, excluded items may also be generated based on the included diagnosis code. For example, if the diagnosis code indicates a particular disease, and it is known that a particular drug is sometimes used by doctors to treat that particular disease, but it is not an FDA approved treatment, the medicine code and name of the particular drug may be identified as an excluded item. This input of information may be provided internally through lookup tables or externally by a user answering questions.

In accordance with yet another variation, the input data may include particular codes and particular words. The computer creates a subset and then analyzes the subset of data removing the particular words from each patient encounter record in the subset if said each patient encounter record does not include at least one of the particular codes. Thus, the subset will include patient encounter records with the particular words removed and will also include patient encounter records with the particular words included and with at least one of the particular codes included.

In yet another embodiment, the input data includes particular diagnosis identifiers and particular medicine identifiers. When creating the subset, the computer removes at least one of:

(1) all of the particular diagnosis identifiers, and/or

(2) all of the particular medicine identifiers,

from each patient encounter record in the subset. The decision as to what should be removed is based upon the presence or absence of the particular diagnosis identifiers in each patient encounter record and based upon the presence or absence medicine identifiers in each patient encounter record. For example, the particular medicine identifiers may be removed from each patient encounter that does not include at least one of the particular diagnosis codes. Alternatively, the particular medicine identifiers may be removed from each patient encounter that includes at least one of the particular diagnosis codes. When information is removed from an encounter record it may be replaced with nothing as if it never existed, or it may be replaced with a placeholder such as “XXXXXXXX”.

In accordance with yet another embodiment a desired report is created from a computer database for a customer where the database includes a plurality of electronic encounter records with medical information within each encounter record. A set of exclusion data is provided to the computer. The exclusion data is related to medical information that the customer wishes to be excluded from the desired report. Based on the exclusion data, the computer analyzes the electronic patient encounter records to identify a subset of patient encounter records that should be excluded. The computer generates the desired report by including all patient encounter records except for the excluded sub-subset of the patient encounters.

In a variation of this embodiment, based on the particular set of exclusion data, the computer may identify additional exclusion data. Then, based on the original exclusion data and the additional exclusion data, the computer generates the desired report excluding a second subset of patient encounters from the desired report (or excluding a second subset of patient information within the patient encounters).

As a particular example of the above method the exclusion data may comprise particular diagnosis identifiers and particular medicine identifiers. The computer may create a subset that includes patient encounter records based on the presence or absence of at least one of the particular diagnosis identifiers and further based on the presence or absence of at least one of the particular medicine identifiers. For example, a patient encounter record may be excluded from the report if one of the diagnosis identifiers is present in the encounter record and one of the medicine identifiers is also identified in the encounter record. As another example a patient encounter record may be excluded from the report if one of the diagnosis identifiers is not present in the encounter record and one of the medicine identifiers is present in the encounter record.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 illustrates diagnosis records for four patients showing diagnoses for each of five different encounters (Patient Encounter IDs 2886 and 4001 correspond to patient with Patient ID 1764; Patient Encounter IDs 2887, 2888, and 2891 correspond to patients with Patient IDs 1765, 1766, and 1767, respectively);

FIG. 2 is patient information record for four different patients showing a unique Patient ID for each patient;

FIG. 3 is a patient encounter record showing five different encounters with four patients identified in FIG. 2;

FIG. 4. is a patient procedure record for each of the five encounters of FIG. 3;

FIG. 5 is a patient procedure medications record for each of the five encounters of FIG. 3 showing a medication name, procedure notes, and a medication code; and

FIGS. 6A-6E are patient finding records showing numerous findings for each of the encounters of FIG. 3.

### DETAILED DESCRIPTION

### Diagnosis Record Example

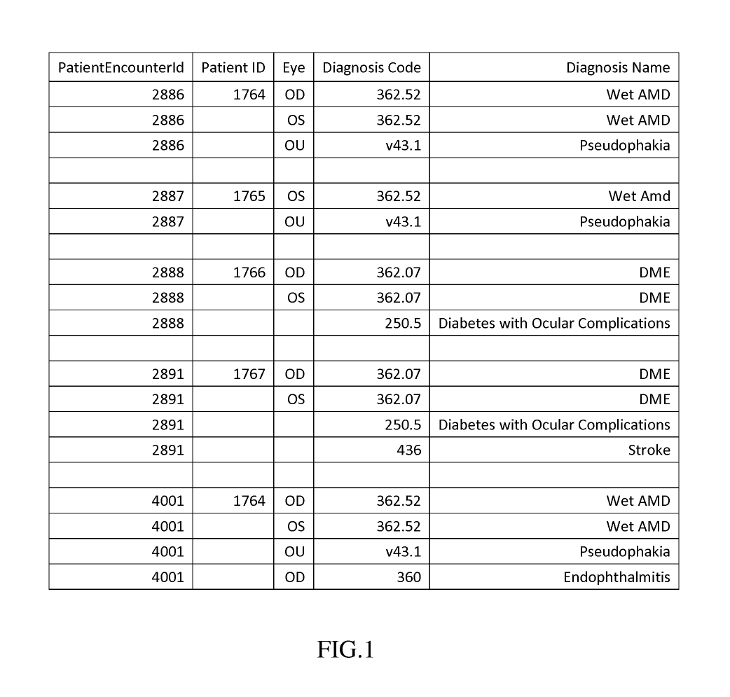

The methods of the present invention are implemented on computer systems that store medical records and may include computers owned by physicians, hospitals, other health care providers, outside vendors supplying computer record services to health care providers, a database owner, and customers interested in purchasing medical information. These computers are typically in different locations but are connected by intranet or internet connections. Referring to FIG. 1, there is shown in abbreviated exemplary subset of a medical record for purposes of explaining various embodiments of the invention. FIG. 1 shows only a few medical diagnosis records for only four patients and it represents the medical records that were pulled from a larger database based on a request from a customer.

To begin the preparation of a report in accordance with this embodiment, a database of medical records stored on a computer is first searched for terms of interest. Any patient encounter record that satisfies terms of interest will be returned as “hits”. Then the hits are analyzed to determine whether any information should be excluded based on the customer search request and various internal and external rules. Alternatively, all records in the database may be analyzed.

Referring to FIG. 1, a simple subset of a medical database is shown. The patients are identified only by a code and thus these medical records have been de-identified in accordance with U.S. patent application Ser. No. 14/077,714, filed Nov. 12, 2013, entitled Healthcare Data Management System, which is incorporated herein by reference. In this case, in FIG. 1 five patient encounters are listed in the first column, numbered 2886, 2887, 2888, 2891, and 4001. In the second column the patient identification numbers are shown as follows 1764, 1765, 1766 and 1767. In the fourth column a diagnosis code is provided. In this hypothetical, the subset shown in FIG. 1 was generated by searching a database for Lucentis or Eylea or Vancomycin. Elsewhere in the medical records these search words appeared.

As used in the figures, the ICD9 codes of interest are as follows:

362.52 is exudative AMD (macular degeneration)

V43.1 is pseudophakia (ie a patient who has had cataract surgery)

360.00 is endophthalmitis, an infection of the eye

362.07 is diabetic macular edema (diabetic eye disease)

250.5 is systemic diabetes with ocular complications

436 is stroke

The following abbreviations are used in the Figures:

OD is right eye

OS is left eye

OU is both eyes

Assume that the customer had further requested that off-label uses for these drugs not be reported. The program would then analyze and further modify the report. As shown in FIG. 1, column four, Patient 1765 has macular degeneration (code 362.52) in both eyes and has had cataract surgery (code v43.1). To determine whether any information should be deleted with respect to this patient, a lookup table is consulted. The table includes entries for each of the drugs mentioned above and those entries are correlated to inclusion data and exclusion data. In this case, the macular degeneration code 362.52 and the cataract surgery code v43.1 is found in the inclusion data for Lucentis and Eylea. Thus, for patient 1765, the computer selects the diagnosis records for patient encounter record 2887 related to patient 1765 for inclusion in the final report that is ultimately transmitted to the customer.

Patient 1764 has macular degeneration in both eyes and has had cataract surgery. However, the patient also has a diagnosis endophthalmitis in encounter 4001. The computer again checks the lookup table and discovers that the code 360.00 and/or the word “endophthalmitis” is found in the exclusion data correlated with Lucentis and Eylea. Thus, the customer would not want to see code 360.00, so the computer program removes the code 360.00 from the medical record when it generates the report that is sent to the customer. The customer still wants the other information on that patient. So the program selects everything else in that encounter record except that one code (embodiment 1) and includes the other information in the final report. The decision to include the other information was made by the customer before the report was generated.

Alternatively, the customer could provide input data requesting that the program delete an encounter altogether if any of the exclusion data is located in the encounter. So, in this case, in this alternate embodiment, all data on patient 1764 related to encounter 4001 (listing code 360.00) would be eliminated. However, all data on patient 1764 related to encounter 2886, prior to the development of endophthalmitis, would be included.

Patient 1766 has diabetic macular edema in both eyes and systemic diabetes. Elsewhere in the encounter records for this patient, it is shown that the patient an Eylea injection. However, Eylea is not approved for diabetic macular edema. So the Eylea manufacturer does not want to see where their medication was used off-label. Since these encounters all included the word Eylea and/or a code for that medication, the lookup table is consulted for Eylea and the table indicates that code 362.07 is an excluded code. So, again, the program may either remove these encounters altogether, or it could only remove the diagnosis code elements, or it could remove the name and code of the drug. All of the other elements (clinical findings, visual acuity, etc) may be included in the final report because that is still valuable information. Again, the program decides what information to remove based on initial customer instructions or, in the absences of customer instructions, based on internal rules. As before, the customer may instruct the program to remove an entire encounter record if it includes any of the exclusion data.

Customer Input

To begin the search process, the computer program must receive information from the customer as to what search is needed. Preferably, this information is provided directly by the customer through a customer portal, such as a computer, tablet or smart phone. The process begins by asking questions that will dictate the type of search that is performed and the type of report provided. Below is an exemplary set of questions and answers using fictitious codes and random diseases or drugs.
Question: What drug or product are you interested in?
Answer: lucentis
Question: What codes and words do you want to see?
Answer:
   diagnosis codes: 123
   medication codes: 345, 678
   treatment codes: 910
   words: macular degeneration, lucentis
Question: If a patient encounter record includes extra codes that you have not chosen above, which of the below options should be applied? (Check one box.)
Answer:
______A. The entire patient encounter record with extra codes should be excluded from the report.
XXB. The patient encounter record with extra codes should be included in the report, and the extra codes should be removed.
______C. The patient encounter record should be included in the report and the extra codes should also be included in the report.
Question: What diagnosis code and words do you NOT want to see?
Answer:
   diagnosis codes: 234
   medication codes: 689
   treatment codes: none
   words: colorectal cancer
Question: If a patient encounter record includes codes or names that you have chosen NOT to see, which of the below options should be applied?
XXA. The entire patient encounter should be excluded from the report.
______B. The patient encounter record should be included in the report, and the excluded codes and excluded names should be removed.
______C. The patient encounter record should be included in the report and the excluded codes and the excluded names should be shown as redacted from the report.

In response to the answers to the questions above, the computer program will first conduct a search of the de-identified medical records looking for the codes 123, 345, 678 and 910. It will also search for the words macular, degeneration and Lucentis. If any of those codes or words are found in a patient encounter record, the patient encounter record is included in a subset of the de-identified medical records. The subset of medical records is then processed in accordance with the answer to question C. In this particular case, the subset will be searched for any codes other than the above listed codes. If such other codes are found in the patient encounter records, such other codes are removed or deleted leaving behind only empty space. Had the user checked box A, the entire patient encounter record with extra codes would have been deleted. If box C had been checked, the patient record would be included in the report and the extra codes would also be shown in the report.

After the above analysis, the computer program continues to analyze the subset. In response to questions D and E, the program will recognize that there is a conflict between the instructions provided in response to question C and in response to question E. With respect to the excluded codes and words, identified in response to question D, the customer has requested that the entire patient encounter record be excluded from the report. Such excluded codes would also be “extra codes” that were identified in response to question B. For those extra codes, the customer has requested that the extra codes be removed, but the patient encounter record should be included in the report. The program will take the more exclusive approach, meaning that it will analyze the original subset and it will exclude patient records that include the excluded codes and words identified in response to question D. Then, after such patient records have been excluded, the program will remove the “extra codes” from the subset which creates a sub-subset in which some of the encounter records have been removed and some codes and words have been removed from the remaining encounter records. A report is generated for the customer based on the information in the sub-subset.

In the above embodiments, the customer is prompted by the computer to make a series of decisions that may be confusing to some customers. In an alternate embodiment, the customer is asked to describe the information to be included in the report. The customer may respond by describing information to be included or excluded or both. The program then responds to the description based on a set of internal rules to develop a search strategy. In general, the program searches for words and codes that are mentioned positively by a customer. If the customer mentions words or codes in a negative context, those words and codes are redacted from the records and replaced with “XXX” or the like. For example, if the customer said: “I want to see things on Lucentis but don't include off-label uses.” The program interprets this sentence as requesting a report on Lucentis because is follows a positive verb. It interprets off-label uses as exclusion data because it follows a negative verb structure (don't). In this case, since the customer provided exclusion data, information is redacted from the report based on the exclusion data, and no other information is redacted or omitted.

In another simplified embodiment, the search strategy is heavily biased to exclude certain types of data that most customers do not want to see. For example, if a customer just requested a report on “Lucentis” and provided no negative input, this embodiment will automatically assume that the customer does not want to see off-label uses or possible adverse side effects of Lucentis. Thus, by default the computer will redact information from the report that indicates off-label uses or possible adverse side effects based on a look up table for Lucentis that identifies the things that should not be reported if the customer requests only a Lucentis report and provides no other information. Alternatively, the computer will not report an encounter in which off-label uses or possible adverse side effects are found. In this embodiment, a customer can request to see the search strategy and it will be provided, but the default report would not include the search strategy.

Exemplary Data

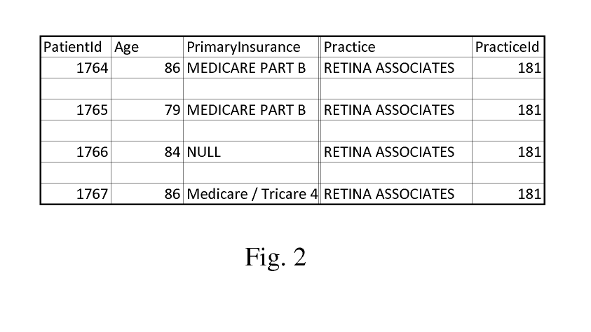

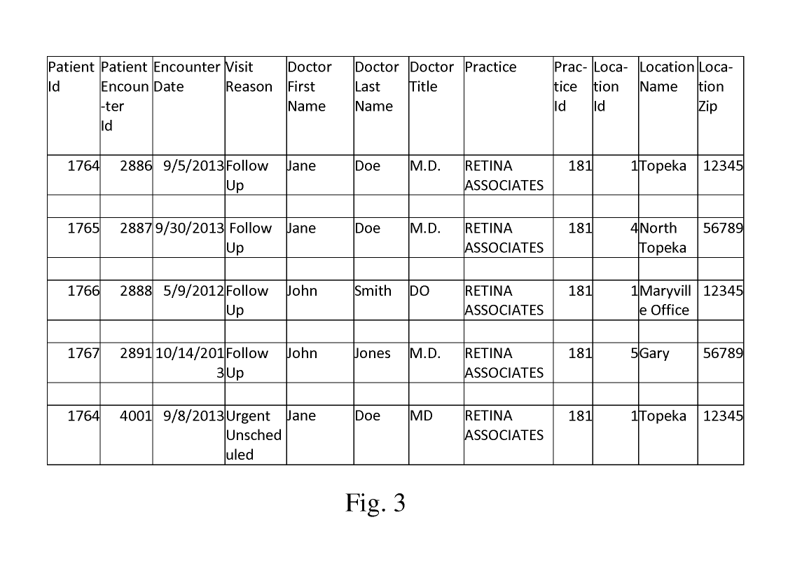

The data shown in FIGS. 1-6 represent a more complex example than those discussed above but the data is still simplified for ease of discussion. The data includes five encounters (encounter numbers 2886, 2887, 2888, 2891, and 4001) from four patients (patients 1764, 1765, 1766, and 1767). The basic patient data is shown in FIG. 2, and the encounter records are shown in FIG. 3.

As shown in FIGS. 1, 3 and 4, Encounter 2886 is for Patient 1764. Patient 1764 has bilateral (OU) wet AMD (macular degeneration) and at encounter 2886 received bilateral injections of Eylea. Wet AMD is an on-label indication for Eylea.

Encounter 2887 is for Patient 1765. Patient 1765 has wet AMD in the OS and at encounter 2887 received a Lucentis 0.5 mg injection OS. Wet AMD is an on-label indication for Lucentis 0.5 mg.

Encounter 2888 is for Patient 1766. Patient 1766 has Diabetic Macular Edema (DME) in the both eyes (OU) and at encounter 2888 received an Eylea injection OU. DME is off-label (unapproved) for Eylea.

Encounter 2891 is for Patient 1767. Patient 1767 has Diabetic Macular Edema (DME) in both eyes (OU) and at encounter 2891 received Lucentis 0.3 mg injection OU. DME is an on-label indication for Lucentis 0.3 mg. Note also, however, that this patient also received a diagnosis of acute stroke (ICD9 code 436) at this visit which would be considered an adverse event.

Encounter 4001 is again for Patient 1764, but this is a follow-up visit from encounter 2886. This time the patient presents with a complication (endophthalmitis, aka infection in the eye, ICD9 360) in the OD potentially due to an Eylea injection they received at encounter 2886. At encounter 4001 they receive an intravitreal injection of vancomycin in the right eye to treat that infection.

FIG. 2 is a worksheet called “Patients” and provides the Patient IDs and some information on each patient. Each patient has a unique numerical PatientID that is the same for each office visit.

The third worksheet, FIG. 3, “Encounters” ties each patient to a specific encounter. Each encounter receives a numerical ID. It is this “PatientEncounterID” that ties all the worksheets together.

Each worksheet is for a different element of the patient encounter (diagnoses at that encounter, medications at that encounter, etc). Each worksheet includes the PatientEncounterID and the clinical elements associated with that encounter. So for each worksheet we have information from several encounters.

So, for each worksheet (FIGS. 1-6), it is the PatientEncounterID that ties the findings to each patient. The PatientID is not needed on each worksheet as the PatientEncounterID indirectly provides the PatientID by cross-referencing the Encounters worksheet.

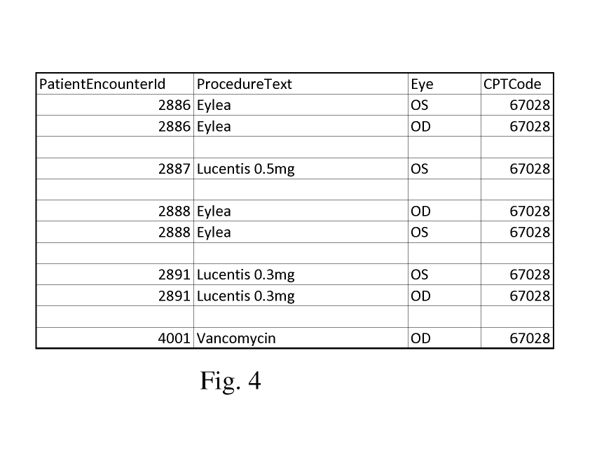

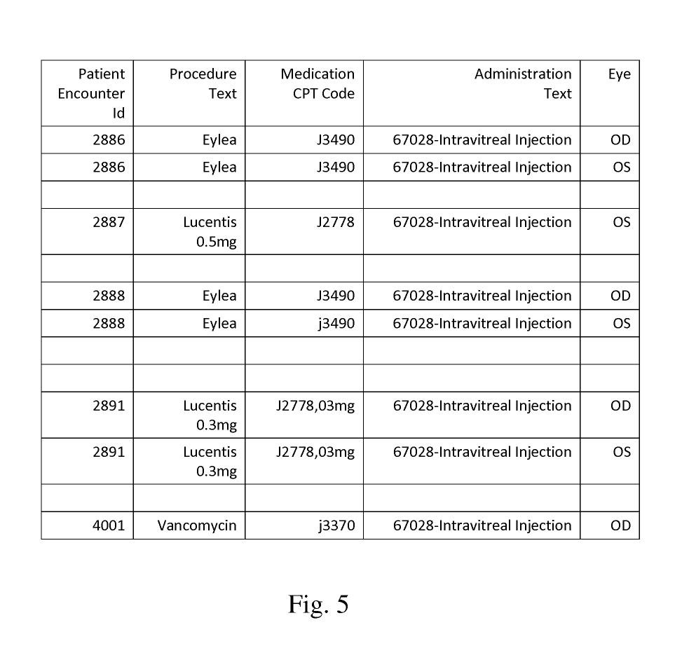

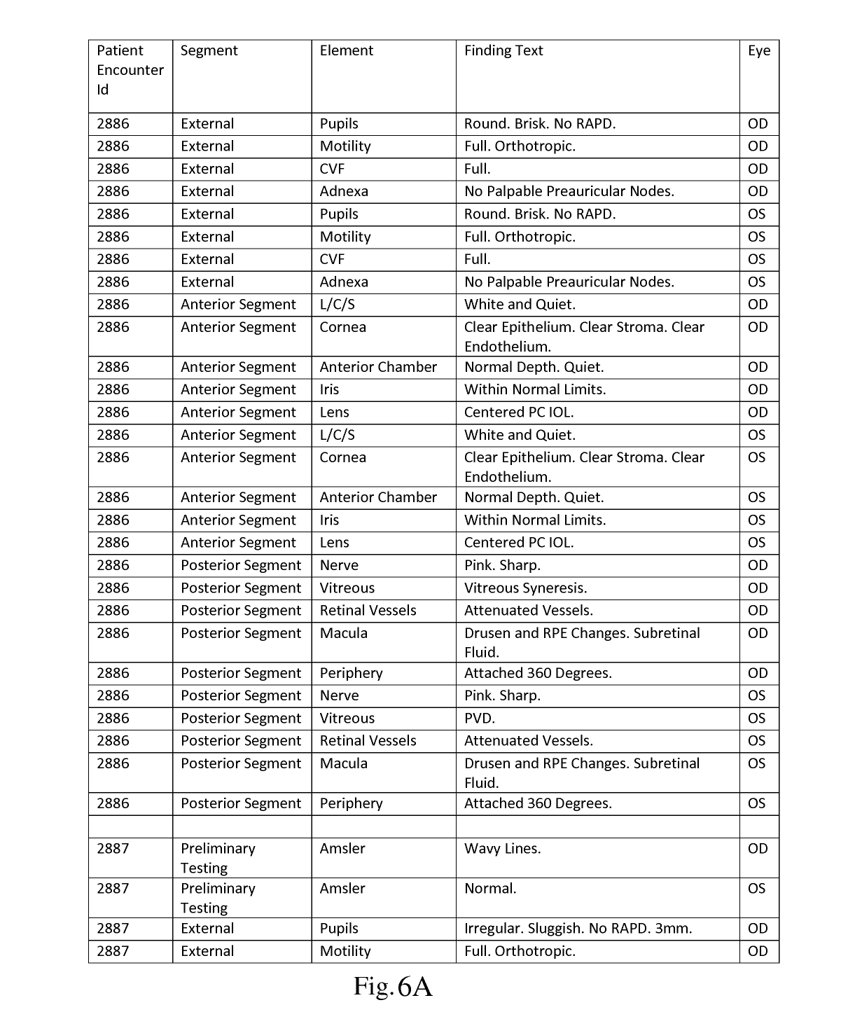

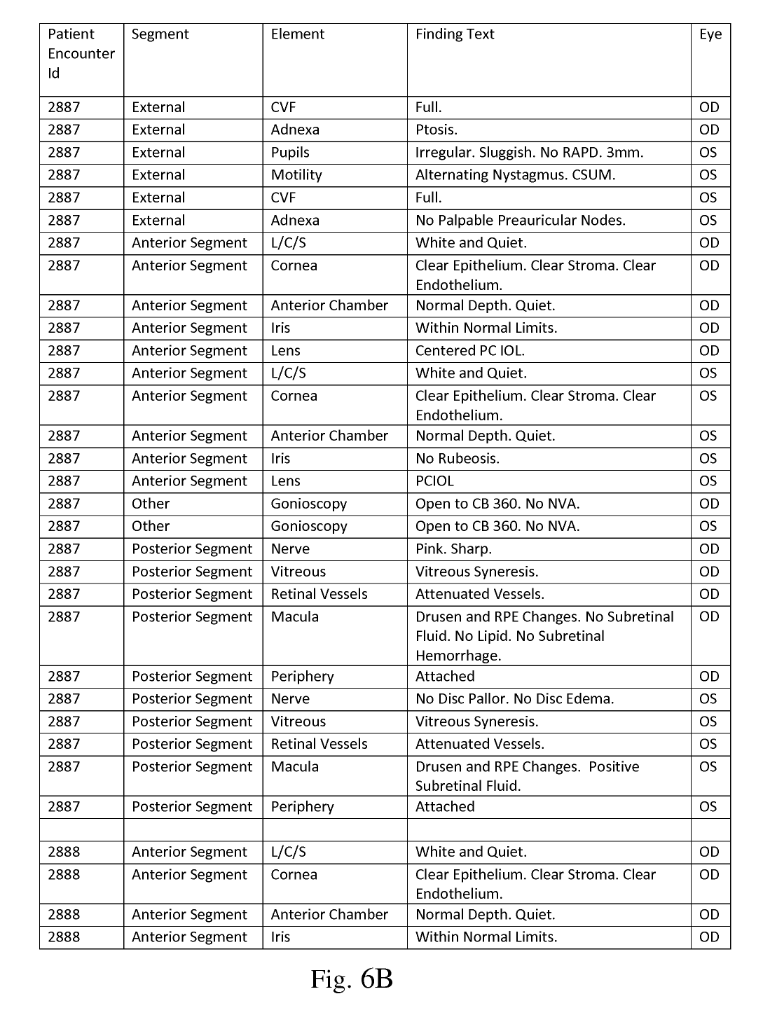

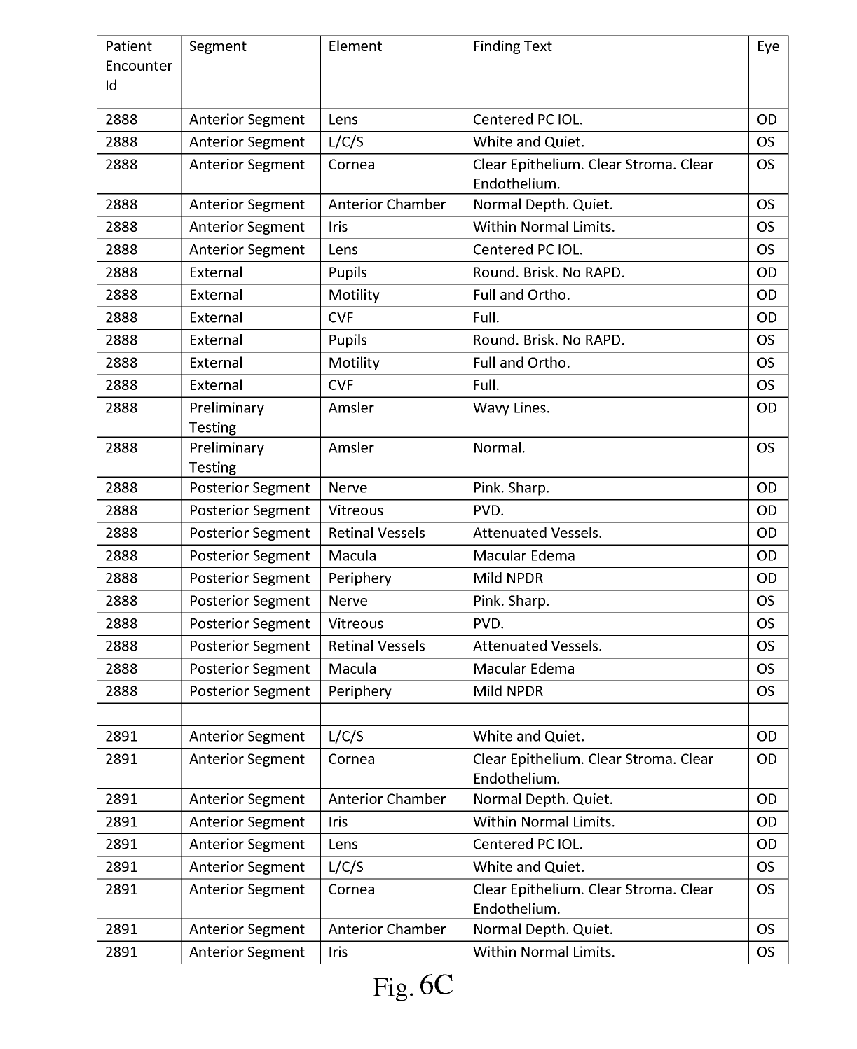

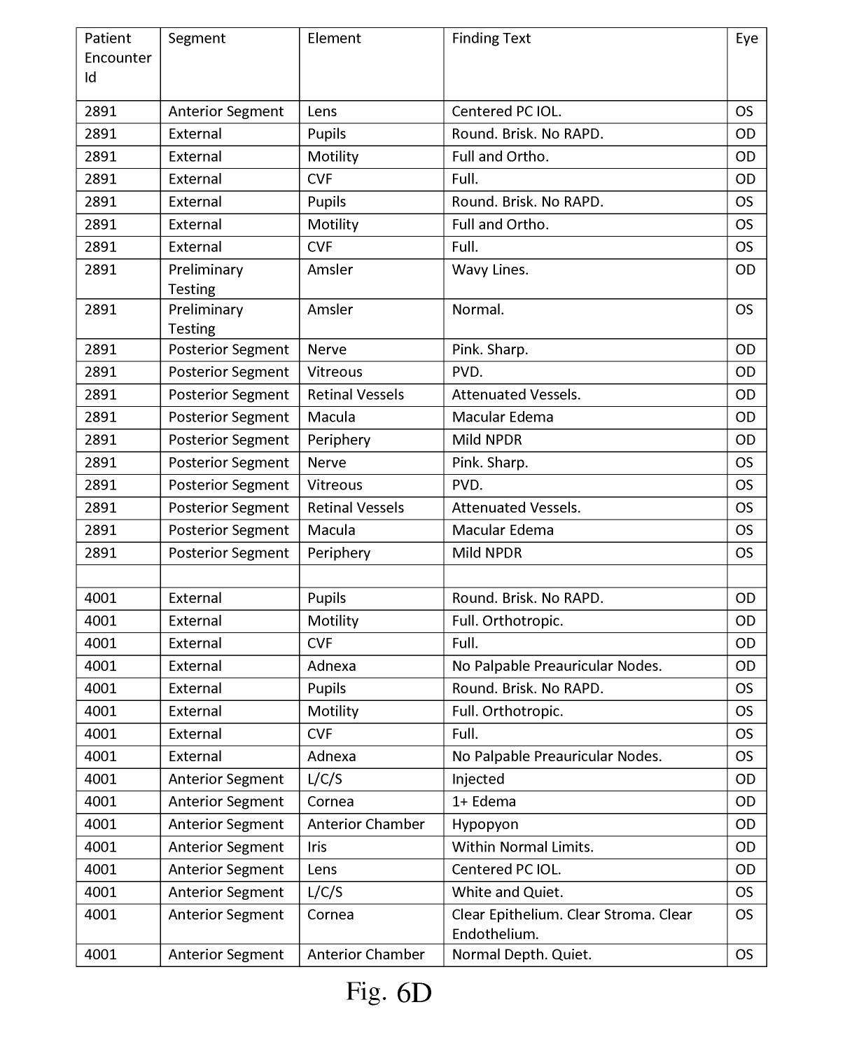

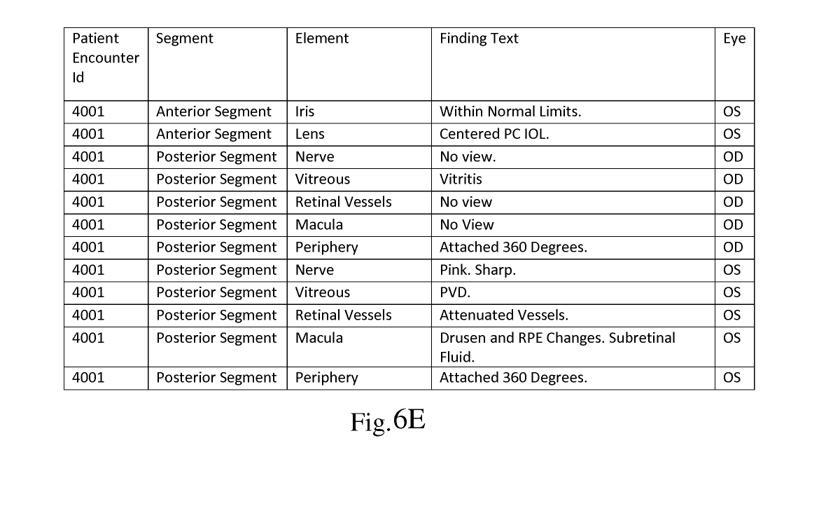

The worksheets of interest for this example are “patients” (FIG. 2), “encounters” (FIG. 3), “procedures” (FIG. 4), “procedure medications” (FIG. 5), “patient encounter findings” (FIGS. 6A-6E) and “diagnosis” (FIG. 1). Procedure Medications” is essentially the same as “Procedures” with additional information such as medication CPT code.

Below are some representative examples of how the embodiments in the application would be applied to the medical data to create a customer report. First, the customer inputs the following:
Question: What medicine or product are you interested in?
Answer: Lucentis, Eylea
Question: If an encounter indicates an off-label use of a medicine, what should be included in the report? Select only one answer.
Answer:
______Include all information about off-label use.
______delete the entire encounter from the report,
XX delete the medicine name and medicine code, but report the rest of the encounter record, or
______delete all information about off-label use, but report the rest of the encounter record.
Question: If an encounter indicates an adverse event that may be related to the medicine or product of interest, what should be included in the report? Select only one answer.
Answer:
______Include all information about off-label use.
XX delete the entire encounter from the report,
______delete the name and medicine code, but report the rest of the encounter record, or
______delete all information about off-label use, but report the rest of the encounter record.

In this case the customer is interested in Lucentis and Eylea, and the customer wants the medicine name and code deleted if off-label use is indicated.

The program first analyzes encounter 2886. It searches the encounter for Lucentis or Eylea. It finds Lucentis, which is a medicine of interest. The program then determines the patient ID is 1764 based on the encounter records at FIG. 3 and it finds and retrieves all encounter records for patient 1764, which are records 2886 and 4001. The program then consults the lookup table which includes the following entry:

| | | | Excluded | Excluded |
|---|---|---|---|---|
| | Med | | Off-Label | Adverse |
| Medicine | Code | Inclusion | Use | Event |
| Eylea | j3490 | Wet AMD, 362.52 | DME, | stroke, 436, 360, |
| | | | 362.07, | Endophtalmitis |
| Lucentis | j2778 | Wet AMD, 362.52, | | stroke, 436, 360, |
| | | DME, 362.07 | | Endophtalmitis |

Based on the lookup table, the program determines that Wet AMD and code 362.52 are included terms for Lucentis and both terms are found in the encounter records 2886. Thus the program initially includes both records 2886 and 4001. However, the program also determines that “Stroke” and “Endophthalmitis” are found in encounter 4001 and both are excluded adverse events. Based on the instructions provided by the customer, encounter record 4001 is entirely excluded from the report to the customer.

The program continues its analysis by moving to the next patient encounter that has not yet been analyzed, which is encounter 2887. Checking FIG. 3, it is determined that the patient ID is 1765 and all encounter records for patient 1765 are pulled. In this case there is only one. Patient 1765 has wet AMD in the OS and at encounter 2887 received a Lucentis 0.5 mg injection OS. Referring to the lookup table above, the program determines that Wet AMD is an on-label indication for Lucentis 0.5 mg. None of the excluded terms are found for this patient, so the report will include all information for this patient.

The program then moves to Encounter 2888. Here we have an off-label utilization of a medication. Based on the instructions, the program deletes “Eylea” and “J3490” from the entire encounter 2888, but includes other information related to the encounter in the report less the excluded items.

The program then moves to the next unexamined encounter, and it finds encounter 2891. This encounter is initially included because it has some of the included items based on the customer instruction. However, it also includes an adverse event and code, Stroke and 436, and thus, the entire encounter record 2891 is excluded from the report.

The program may be set up to exclude or include data according to a variety of rules internal to the program and rules based on different instructions provided by the customer. As an example of an internal rule, assume the customer had only identified Excluded Off-Label uses. The program may have an internal rule to exclude any encounter that includes such Off-Label uses, but include every other encounter in the database. In an alternate embodiment, the internal rule for the same instructions may be to remove the name and code of the excluded off-label use, and include the encounter in the report.

As an example of changing rules based on customer instructions, the same situation above may be controlled by questions to the customer. For example, assume the customer has provided only excluded off-label uses. In this case, the program may respond with the question and answers shown below:
Question: You have provided only excluded off-label uses. What do you want in the report:
______All encounters in the database except the excluded off-label uses.
______All encounters in the database, including encounters that contain the off-label uses, with the off-label words and off-label codes redacted from the report.
______Only encounters in the database that include the off-label uses, with the off-label words and off-label codes redacted from the report.

Whether the program is responding to internal rules (which are typically provided in a lookup table) or external rules provided by the customer in response to questions or other input, the rules govern what data is excluded and how data is excluded. If included items and excluded items are provided by the customer, the excluded instructions will always take precedence over the included instructions. Also, the program must make a decision as to encounter records that do not include either the included items or the excluded items. The most obvious solution would be to exclude such records, but alternatively such records could be entirely included, or, alternatively such records could be included with diagnosis words and codes redacted and/or with medicine words and codes redacted.

Continuing with the example above, consider encounter 2891. Depending upon internal and external rules, the following embodiments could emerge:
a) One embodiment would be to remove the procedure name/drug name (Eylea) and the drug code (j3490) from the report in worksheets Procedures and Procedure Medications but leave all of the other information in the report.
b) Another embodiment would be to remove the diagnosis name (DME) and diagnosis code (362.07) from the report in the Diagnosis worksheet, but leave all the other information in the report.
c) Another embodiment would be the remove Encounter 2888 from the report altogether, but leave all other encounters.

Consider Encounter 2891. Here we have an encounter with a potential adverse (stroke) event associated with a medication.
a) One embodiment would be to remove the diagnosis name (stroke) and diagnosis code (436) from the report in the Diagnosis worksheet, but leave all the other information in the report.
b) Another embodiment would be to remove Encounter 2891 from the report altogether, but leave all other encounters.
c) Another embodiment would be to remove all medicine names and codes, such as Lucentis and J2778.

Consider Encounter 4001. Here we have an encounter with a potential adverse event (endophthalmitis) associated with an injection, and also a procedure (intravitreal vancomycin injection) that would reasonably imply that endophthalmitis was present. The following different embodiments could be implemented based on internal or external rules.
a) One embodiment would be to remove the diagnosis (endophthalmitis) and diagnosis code (360) from the report in the Diagnosis worksheet, but leave all the other information in the report. Here we would presume that the presence of the procedure Vancomycin and drug code j3370 would not necessarily signify endophthalmitis was present. This presumption would be implemented by internal or external rules as discussed above.
b) Another embodiment would be to remove the procedure name/drug name Vancomycin and drug code j3370 as well as the diagnosis name and diagnosis code from the report, but leave all the other information in the report.
c) Another embodiment would be to remove Encounter 4001 from the worksheet altogether and leave the remainder of the encounters in the report.
d) Another embodiment would be to remove clinical exam findings from the worksheet PatientEncounterFindings that would indicate an adverse event like endophthalmitis. For example, we might remove the word “hypopyon” in the Anteror Segment/Anterior Chamber OD findings for encounter 4001.

In considering the inclusion and exclusion rules discussed above, it is important to observe that the presence of exclusion data may cause the exclusion of something other than the exclusion data. For example, a rule may provide that if exclusion data is present, then the inclusion data must be excluded. For example, assume that the inclusion data is a list of medicine identifiers (names and codes) and the exclusion data is a list of diagnosis identifiers (names and codes). The rule may provide that if a particular encounter includes an excluded diagnosis identifiers, then the medicine identifiers are excluded. That is, the medicine identifiers may be redacted or the entire encounter record could be excluded.

Likewise, rules may exclude data based on two sets of inclusion data. For example, first and second sets of inclusion data may be provided. A rule may provide that if an encounter included data from the first set of inclusion data is present, but did not include data from the second set of exclusion data, then something must be excluded. For example, assume that the first set of inclusion data is a list of medicine identifiers (names and codes) and the second set of inclusion data is a list of diagnosis identifiers (names and codes). The rule may provide that if a particular encounter includes one of the medicine identifiers from the first set but does not include one of diagnosis identifiers from the second set, then the medicine identifiers are excluded. That is, the medicine identifiers may be redacted or the entire encounter record could be excluded.

As will be appreciated from the discussion above, the various embodiments of the present invention are primarily concerned with the exclusion of data rather than the inclusion of data. By excluding data the customer is protected from data that he should not view. The exclusion of data can be accomplished automatically with little or no input from the customer, or the customer can participate in the exclusion of data by answering either general questions or detailed questions depending on the customer's preference. Although various embodiments have been disclosed above as examples, it is understood that the embodiments are not intended as limitations on the invention. It is understood that the invention is capable of numerous rearrangements, modifications and substitutions of steps without departing from the spirit of the invention as set forth in the appended claims.

What is claimed is:

1. A method of creating on a computer a desired report from a computer database for a customer, comprising:
receiving from health care providers a plurality of electronic encounter records and creating a computer database including a plurality of electronic encounter records with medical information within each encounter record;
receiving input data related to medical information that the customer wishes to be included in the desired report and to be excluded from the desired report;
computer analyzing the patient encounter records in the database to identify and select a subset of patient encounter records based on the input data;
based on the input data provided by the customer, computer analyzing the subset of patient encounter records to remove medical information from the subset and thereby create a sub-subset of medical information that does not include the excluded medical information;
computer generating the desired report from the patient encounter records based on the sub-subset of medical information.

2. The method of claim 1 wherein:
the input data includes one or more desired codes that the customer wishes to include in the desired report;
the step of computer analyzing the patient encounter records further comprises identifying and selecting the subset of encounter records based upon the desired codes so that the subset of encounter records includes the desired codes and includes other codes;
the step of computer analyzing the subset further comprises identifying and selecting a sub-subset of medical information that includes all of the desired codes in the subset but removes the other codes; and
the generating step further comprises generating the desired report from the sub-subset so that the desired report includes the desired codes and other medical information but does not include other codes.

3. The method of claim 1 wherein:
the input data includes one or more excluded codes that the customer wishes to exclude from the desired report;
the step of computer analyzing the patient encounter records further comprises identifying and selecting the subset of encounter records based upon the excluded codes so that the subset of encounter records includes both the excluded codes and other codes;
the step of computer analyzing the subset further comprises identifying and selecting a sub-subset of medical information that excludes the excluded codes but includes other codes and other medical information.

4. The method of claim 1 wherein:
the input data includes one or more desired words that the customer wishes to include in the desired report;
the step of computer analyzing the patient encounter records further comprises identifying and selecting the subset of encounter records based upon the desired words so that the subset of encounter records may include both the desired words and other words;
the step of computer analyzing the subset further comprises identifying and selecting a sub-subset of medical information that includes the desired words but excludes other words based on the desired words.

5. The method of claim 1 wherein:
the input data includes one or more excluded words that the customer wishes to exclude from the desired report;
the step of computer analyzing the patient encounter records further comprises identifying and selecting the subset of encounter records based upon the excluded words so that the subset of encounter records may include both the excluded words and other words;
the step of computer analyzing the subset further comprises identifying and selecting a sub-subset of medical information that excludes the excluded words but may include other codes and other medical information.

6. The method of claim 1 further comprising identifying included groups and excluded groups of medical information based on the input data, and wherein:
the step of computer analyzing the patient encounter records comprises identifying and selecting the subset of encounter records based on the included group of medical information so that the subset of encounter records may include both the included and excluded groups of medical information;
the step of computer analyzing the subset comprises identifying and selecting a sub subset of medical information in the subset of encounter records that excludes the second group of medical information; and
the generating step further comprises generating the desired report from the sub subset so that the desired report includes the first group of medical information but does not include the second group of medical information.

7. The method of claim 6 wherein the excluded groups comprise excluded codes and excluded words related to the excluded codes.

8. The method of claim 6 wherein:
the excluded groups comprise excluded codes; and
the step of computer analyzing the subset comprises generating excluded words based on the excluded codes, and identifying and selecting a sub-subset of medical information in the subset of encounter records that excludes the excluded codes and the excluded words.

9. The method of claim 1 further comprising identifying first and second groups of diagnosis codes based on the input data and wherein:
the step of computer analyzing the patient encounter records comprises identifying and selecting the subset of encounter records based on the first group of diagnosis codes so that the subset of encounter records may include both the first and second groups of diagnosis codes;
the step of computer analyzing the subset comprises identifying and selecting a sub subset of medical information from the subset of encounter records that excludes the second group of diagnosis codes; and
the generating step further comprises generating the desired report from the sub subset so that the desired report includes the first group of diagnosis codes but does not include the second group of diagnosis codes.

10. The method of claim 9 wherein:
the step of computer analyzing the subset comprises generating excluded words based on the excluded diagnosis codes, and identifying and selecting a sub-subset of medical information in the subset of encounter records that excludes the excluded codes and the excluded words.

11. The method of claim 1 further comprising identifying first and second groups of treatment codes based on the input data and wherein:
the step computer analyzing the patient encounter records comprises identifying and selecting the subset of encounter records based on the first group of treatment codes so that the subset of encounter records may include both the first and second groups of treatment codes;
the step of computer analyzing the subset comprises identifying and selecting a sub subset of medical information from the subset of encounter records that excludes the second group of treatment codes; and
the generating step further comprises generating the desired report from the sub subset so that the desired report includes the first group of treatment codes but does not include the second group of medical information.

12. The method of claim 1 wherein:
the input data further comprises particular codes and particular words;
the step of computer analyzing the subset comprises removing the particular words from each patient encounter record in the subset if said each patient encounter record does not include at least one of the particular codes so that the subset includes patient encounter records with the particular words removed and includes patient encounter records with the particular words included and with at least one of the particular codes included.

13. The method of claim 1 wherein:
the input data further comprises particular diagnosis identifiers and particular medicine identifiers;
the step of computer analyzing the subset comprises removing at least one of the group comprising:
(1) all of the particular diagnosis identifiers and
(2) all of the particular medicine identifiers
from each patient encounter record in the subset based upon the presence or absence of the particular diagnosis identifiers in said each patient encounter record and based upon the presence or absence of the particular medicine identifiers in said each patient encounter record.

14. The method of claim 13 wherein the particular medicine identifiers are removed from said each patient encounter if said each patient encounter record does not include at least one of the particular diagnosis codes.

15. The method of claim 13 wherein the particular medicine identifiers are removed from said each patient encounter if said each patient encounter record includes at least one of the particular diagnosis codes.

16. The method of claim 1 wherein the step of computer analyzing the subset comprises removing information from the subset and replacing the removed information with a placeholder to indicate that information has been removed to thereby create the sub-subset.

17. A method of creating a desired report from a computer database for a customer, the database including a plurality of electronic encounter records with medical information within each encounter record, the method comprising:
receiving a particular set of input data related to medical information that the customer wishes to be excluded from the desired report;
based on the particular set of input data, computer analyzing the electronic patient encounter records to identify a subset of information that should be excluded from the report; and
computer generating the desired report from the patient encounter records and excluding the subset of information from the desired report.

18. The method of claim 17 further comprising:
based on the input data, computer identifying additional information that should be excluded from the report; and
based on the additional information, computer analyzing the patient encounter records to identify a second subset of information that should be excluded from the report; and
computer generating the desired report from the patient encounter records and excluding the second sub-subset of information from the desired report.

19. The method of claim 18 further comprising:
storing in the computer first and second sets of exclusion data, with each item of exclusion data in the first set being correlated to one or more items of exclusion data in the second set;
wherein the computer analyzing step further comprises:
computer searching the first set for each item in the particular set of input data to thereby identify found items in the first set,
for each found item in the first set, identifying and storing in the computer identified items in the second set that are correlated to said each found item of the first set; and
based on the identified items of the second set, computer identifying a second subset of information that should be excluded from the desired report; and
wherein the generating step further comprises:
computer generating the desired report from the patient encounter records excluding the second subset of information from the desired report.

20. The method of claim 17 wherein:
the exclusion data further comprises particular diagnosis identifiers and particular medicine identifiers;
the step of computer analyzing comprises including within the subset, patient encounter records based on the presence or absence of at least one of the particular diagnosis identifiers and based on the presence or absence of at least one of the particular medicine identifiers.

21. The method of claim 20 wherein selected information is excluded from the report if one of the diagnosis identifiers is present in the encounter record and one of the medicine identifiers is also present in the encounter record.

22. The method of claim 20 wherein selected information is excluded from the report if all of the diagnosis identifiers are absent in the encounter record and one of the medicine identifiers is present in the encounter record.

23. A method of creating on a computer a desired report from a computer database for a customer, comprising:
receiving from health care providers a plurality of electronic encounter records and creating a computer database including a plurality of electronic encounter records with medical information within each encounter record;
receiving input data related to medical information that the customer wishes to be included in the desired report and to be excluded from the desired report;
computer analyzing the patient encounter records in the database to identify and select a subset of patient encounter records based on the input data;
based on the input data provided by the customer, computer analyzing the subset of patient encounter records to remove medical information from the subset and thereby create a sub-subset of medical information that includes all of the patient encounter records of the subset with the excluded medical information removed from the patient encounter records;
computer generating the desired report from the patient encounter records based on the sub-subset of medical information.

24. The method of claim 23 wherein:
the input data is a medicine identifier;
the step of computer analyzing the subset comprises consulting a rules table to determine adverse diagnosis identifiers that are correlated to the medicine identifier in the rules table and redacting from the subset all adverse diagnosis identifiers based on the rules table.
